(19) United States
(12) Patent Application Publication
(10) Pub. No.: US 2013/0025890 A1
(43) Pub. Date: Jan. 31, 2013

(54) Faceted, Self-Cleaning Compactor Tip

(71) Applicants: Randy E. Schoepke, Lacon, IL (US); Michael H. Hinrichsen, Congerville, IL (US)

(72) Inventors: Randy E. Schoepke, Lacon, IL (US); Michael H. Hinrichsen, Congerville, IL (US)

(73) Assignee: CATERPILLAR, INC., Peoria, IL (US)

(21) Appl. No.: 13/191,063

(22) Filed: Jul. 26, 2011

(51) Int. Cl. B60B 15/02; E01C 19/25; E02D 3/026

(52) U.S. Cl. 172/554; 301/43

(57) ABSTRACT

A compactor, compactor wheel and compactor wheel tip are disclosed. The shape of the tips substantially prevent refuse from packing in the round of the tips. More specifically, tips having relatively flat or constant side surfaces may lend themselves to adherence of moist or malleable refuse. However, by providing the plurality of surface facets and varying dimensions, angular dispositions and shapes of the surface facets, this ability of the refuse to pack in and around the tips is greatly reduced. Moreover, by providing the plurality of surface facets and side surfaces with the inclusion of shoulders and sharp edges therebetween, the ability of the tip to sever or otherwise destroy the refuse being compacted is improved.

### TECHNICAL FIELD

The present disclosure generally relates to compactors and, more particularly, relates to tips used on compactor wheels for compacting and severing refuse while providing stability and traction.

### BACKGROUND

With certain machines, wheels of the machine are provided with specially designed tips which radially extend from a rim. One example is a land fill compactor (LFC). Landfills include vast quantities of trash and refuse of varied shape, size, weight and texture. LFCs are used to move the refuse around the landfill for processing, or to evenly distribute the refuse across the landfill prior to being covered with soil. More specifically, as the acreage of a landfill is of a finite quantity, it is beneficial to evenly distribute the refuse to take maximum advantage of the available space. In addition, it is beneficial to break down the refuse into smaller pieces to both facilitate this space usage and lessen the time required for disintegration, biodegradation, dissolution, etc. This can be done by either severing the refuse, and/or compacting same.

While effective, the terrain encountered at a landfill by a LFC is as a result very unpredictable and often sparse or inconsistent in nature. Moreover, as the land fill is being continually added to with new debris typically by a dump truck or conveyor, the debris is often initially provided in piles. Over time this can create significant inclines and declines over which the LFC must traverse. To do so, a typical LFC includes four or more wheels having metal rims from which protrude a plurality of spaced and elongated cleats or tips. Such wheels are designed to not only dig deeply into the refuse and provide the traction necessary to navigate, but also chop or otherwise break down the refuse as they rotate.

A particular challenge faced by LFCs is the prevention or abatement of refuse from getting stuck to the rim. This is particularly true of wet or malleable refuse that may pack in, around and between the tips extending from the rim. Over time, such packed material may limit or completely remove both the originally intended compaction and traction goals of the tips, thus potentially limiting or even crippling operation of the machine, as well as decreasing efficiency and increasing fuel consumption. Significant manual labor may also be necessary to continually clean the rims and tips of such packed refuse.

### SUMMARY OF THE DISCLOSURE

In accordance with one aspect of the disclosure, a compactor tip is disclosed which may comprise a tip end, an attachment end, a longitudinal axis extending between the tip end and the attachment end, and a plurality of surface facets disposed between the tip end and the attachment end along the longitudinal axis, wherein each surface facet is radially offset from a longitudinally adjoining surface facet.

In accordance with another aspect of the disclosure, a compactor wheel is disclosed which may comprise a rim, and a plurality of compactor tips radially extending from the rim. Each compactor tip may include a tip end, an attachment end, a longitudinal axis extending from the attachment end to the tip end, and a plurality of surface facets disposed between the tip end and the attachment end along the longitudinal axis, wherein each surface facet is radially offset from a longitudinally adjoining surface facet.

In accordance with yet another aspect of the disclosure, a compactor is disclosed which may comprise a chassis, an engine supported by the chassis, and a plurality of compactor wheels supporting the chassis. Each compactor wheel may include a rim and a plurality of compactor tips radially extending from the rim. Each compactor tip may include a tip end, an attachment end, a longitudinal axis extending from the attachment end to the tip end, and a plurality of surface facets disposed between the tip end and the attachment end along the longitudinal axis, wherein each surface facet is radially offset from the longitudinally adjoining surface facet. These and other aspects and features of the disclosure will be more readily understood upon reading the following detailed description when taken into conjunction with the accompanying drawings.

### BRIEF DESCRIPTION OF THE DRAWINGS

FIG. 1 is a perspective view of a compactor constructed in accordance with the teachings of the disclosure;

FIG. 2 is a perspective view of a compactor wheel constructed in accordance with the teachings of the disclosure;

FIG. 3 is a perspective view of a compactor wheel tip constructed in accordance with the teachings of the disclosure;

FIG. 4 is a top plan view of the compactor wheel tip of FIG. 3.

FIG. 5 is a front view of the compactor wheel tip of FIG. 3;

FIG. 6 is a side view of the compactor wheel tip of FIG. 3;

FIG. 7 is a perspective view of an alternative embodiment of a compactor wheel tip constructed in accordance with the teachings of the disclosure; and

FIG. 8 is a top plan view of the compactor wheel tip of FIG. 7.

While the following detailed description will be made with respect to certain illustrative embodiments, it is to be understood that the scope of the invention should not be so limited thereto, but rather be construed in light of the claims appended hereto and their equivalents.

### DETAILED DESCRIPTION

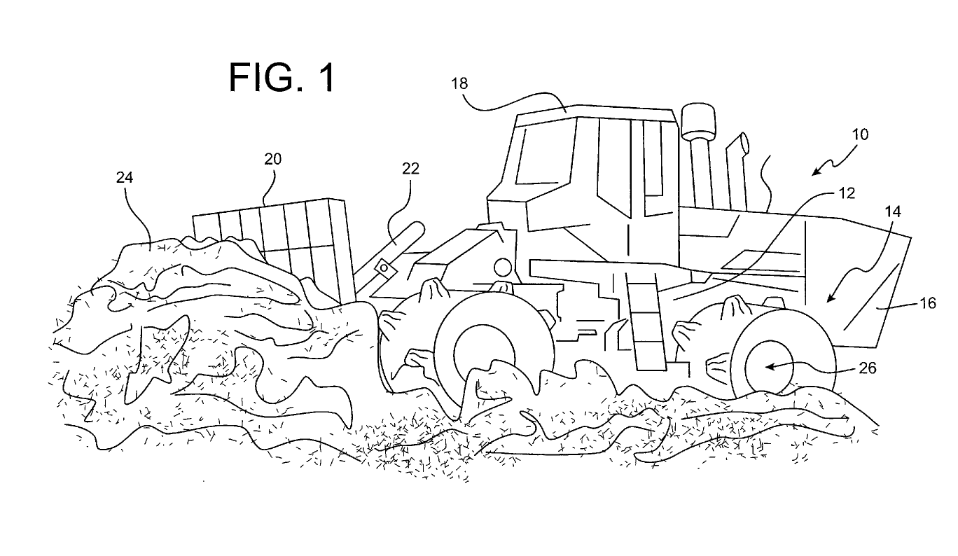

Referring now to the drawings, and with specific reference to FIG. 1, a compactor constructed in accordance with the teachings of the disclosure is generally referred to by reference numeral 10. As indicated above, the compactor 10 may be a landfill compactor (LFC) as shown in FIG. 1, but it is to be understood the teachings of the present disclosure can be used in conjunction with other types of compactors as well as other machines used in agricultural, earth moving, and industrial applications.

The compactor 10 may include a chassis 12 supported by wheels 14. The chassis 12 may support an engine 16 and an operator cab 18. Various implements such as a blade 20 may be mounted on the chassis 12 and be movable by hydraulic cylinders 22 or the like to raise, lower, tilt and turn, and thus manipulate and move debris 24. Each of the wheels 14 may be mounted on an axle 26.

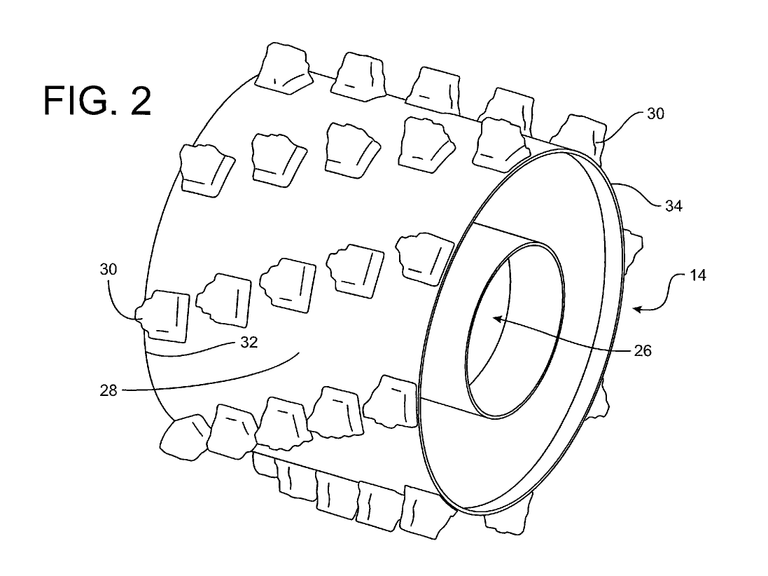

Turning to FIG. 2, each wheel 14 may include an annularly-shaped rim 28 from which radially extend a plurality of cleats or tips 30. As shown, the tips 30 may be provided in a helical pattern laterally across the rim 28 from inner edge 32 to outer edge 34 such as in FIG. 2, an offset pattern (not shown), or in any number of different patterns.

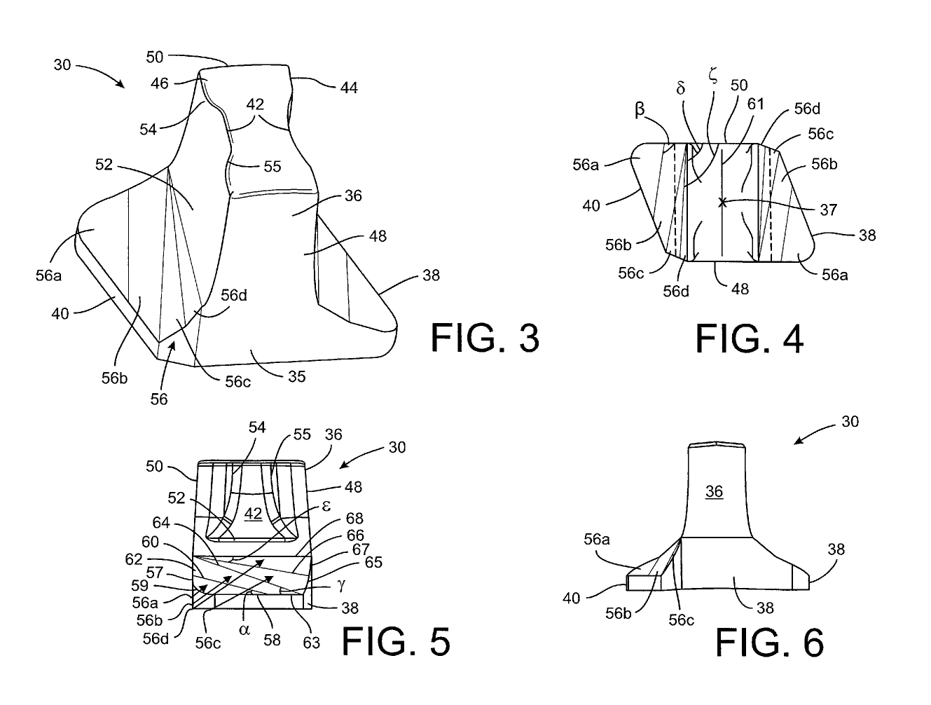

Referring now to FIGS. 3-6, one of the tips 30 is shown in further detail. Starting with FIG. 3, the tip 30 is shown to include a base or attachment end 35 from which an extension or tip end 36 extends. As shown best in FIG. 6, the base 35 supports the extension 36 along a longitudinal axis 37 but that the extension 36 is rotationally twisted relative to the base 35. Accordingly, while the tip 30 includes a forward end 38 and a reverse end 40, the extension 36 does not lie parallel to either but rather transverse to both.

Referring again to FIG. 3, but also with reference to FIG. 5, the extension 36 is shown to include first and second scalloped portions 42 provided in front and back 44 and 46, respectively. Front and back 44 and 46 are substantially perpendicular to sides 48 and 50 of the extension 36, with both sides 48, 50 being substantially planar. The scalloped portions 42 may include a bottom ridge 52 from which side ridges 54 and 55 upwardly extend. The inventors have found that the provision of such scalloped portions 42 is one feature that helps to prevent packing of refuse in and around the tips 30.

Turning now to the base 35, as shown in each of FIGS. 3-6, the base includes a plurality of surface facets 56 which transition the base 35 from a relatively horizontal disposition at surface facet 56a to a substantially vertical disposition provided with surface facet 56d. In the transition from surface facet 56a to surface facet 56d, a progressively aggressive angle relative to the longitudinal axis 37 is taken. In so doing, each surface facet 56 is said to be radially offset from one another. Moreover, not only are the angles of the surface facets 56 relative to the longitudinal axis 37 along a horizontal direction increased from a-d, but it will be noted that each of the surface facets 56 are actually provided at a compound angle relative to the longitudinal axis 37. In other words, each of the surface facets 56 are not only provided at a different horizontal angle, but each are also radially disposed at a different angle relative to the longitudinal axis 37 as well. In so doing, transitions are made with each surface facet 56 in respect with at least two angles relative to longitudinal axis 37. The inventors have found that by providing surface facets 56 at such compound angles, refuse is substantially prevented from packing in and around the tips 30.

While the surface facets 56 can be provided at many different dimensions and angular dispositions and still be within the scope of the present invention, in the depicted embodiment, the surface facets 56 are provided as follows.

Starting with surface facet 56a, it is shown to include a side edge 57, a bottom edge 58, a curved transition 59, and an angled border 60. As shown in FIG. 5, the angled border 60 may be provided at angle α of thirteen degrees relative to the bottom edge, but of course this is only one example, and in other embodiments could be provided at a different angle. Moreover, as shown in FIG. 4, the angled border 60 may also be provided at angle β of ten degrees relative to the horizontal axis 61 of the extension 36. Again, however, this is only exemplary.

With respect to surface facet 56b, it includes the angled border 60, as well as a side edge 62, a second bottom edge 63 and a second angled border 64. As shown in FIG. 5, the second angled border 64 may be provided at an angle γ of nineteen degrees relative to the second bottom edge 63, but other angles are possible. Surface facet 56b is also provided at a compound angle in that the second angled border 64 may be provided at an angle δ of eleven degrees relative to the horizontal axis 61 as shown in FIG. 4. Other compound angles are certainly possible.

Surface facet 56c may include the second angled border 64, a side edge 65, and a third angled border 66. In so doing, it will be noted that the surface facet 56c is triangular in shape. The third angled border 66 may be provided at an angle ζ of ten degrees relative to the second bottom edge 63 as shown in FIG. 5. As shown in FIG. 4, the third angled border 66 may also be provided at an angle of four degrees relative to the horizontal axis 61, but again this is only exemplary.

Surface facet 56d may include the third angled border 66, a side edge 67, and a top edge 68. In so doing, it will be noted that the surface facet 56d is also triangular in shape. As shown in FIG. 5, the top edge 68 is provided parallel to the bottom edge 63, but other angles are possible. In addition, as shown in FIG. 4, the top edge 68 may be provided parallel to the horizontal axis 61, but other angles are possible as well.

The inventors have found that by not only providing the surface facets 56, but providing them at compound angles, the ability of refuse to pack in and around the tips 30 is substantially reduced. Among other things, such a disposition of surface facets avoids large flat surface, as well as acutely angled recesses, which might otherwise lend themselves to adherence of refuse.

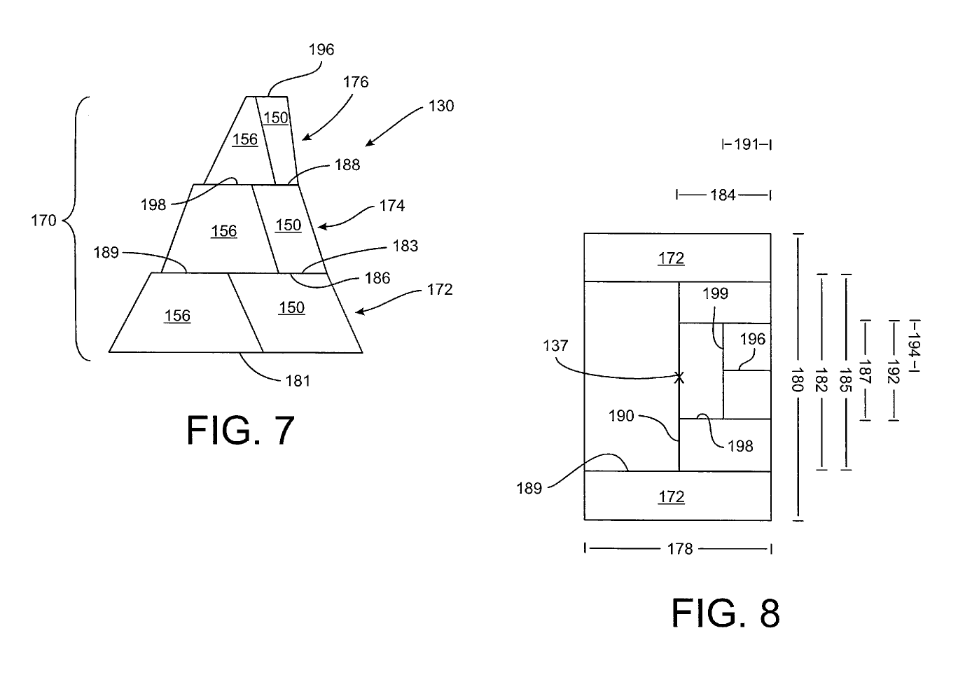

Referring now to FIGS. 7 and 8, an alternative tip 130 is shown in further detail. Starting with FIG. 7, the tip 130 is depicted to include three distinct sections 170 radially positioned and offset from one another. In other alternative embodiments, it is to be understood that more or less sections 170 can be included. More specifically, the tip 130 of FIG. 7 may include a bottom section 172, an intermediate section 174 and a top section 176. Each of the sections 170 may include a plurality of surface facets 156 and a plurality of side surfaces 150. The interaction and disposition of the surface facets 156 and the side surfaces 150 on the tip 130 allow for the improved resistance to refuse packing and improve compaction capabilities of the tip 130, wheel 14 and LOC 10, as will be described in further detail herein.

Starting with the bottom section 172, as shown in FIG. 8, it includes a constant thickness 178 but a width which tapers from its widest point 180 at bottom surface 181 to a most narrow dimension 182 at a top surface 183. It does so by having each one of the side surfaces 150 slope inwardly toward longitudinal axis 137. Next, atop the bottom section 172 is the intermediate section 174 shaped very similarly to the bottom section 172, but with different dimensions. More specifically, the intermediate section 174 may include a constant thickness 184 but a width which tapers upwardly from its widest point 185 at bottom surface 186 to its most narrow point 187 at top surface 188. In addition, it will be noted that the width of the bottom surface 186 of the intermediate section 174 is identical to the width of the top surface 183 of the bottom section 172. In so doing, the side surfaces 152 of the intermediate section 174 and the bottom section 172 form a contiguous constant surface.

However, it will also be noted that the thickness 184 of the intermediate section 174 is substantially less than the thickness 178 of the bottom section 172. In one exemplary embodiment, the thickness 184 is one-half of that of the thickness 178 of the bottom section 172. In so doing, it is said that the intermediate section 174 is radially offset from the bottom section 172. This is perhaps best shown in the top view of FIG. 8. The inventors have found that by providing such radially offset sections, the ability of the refuse to pack against and between tips 130 is substantially reduced.

In order to form the transition between the bottom section 172 and the more slender intermediate section 174, a portion of the top surface 183 of the bottom section 172 forms a shoulder 189 extending between the surface facet 156 of the bottom section 172 to the surface facet 156 of the intermediate section 174. The inventors have found that not only does this shoulder 189 and radially offset orientation of the sections hinder the ability of the refuse to pack as indicated above, but that the shoulders 189, so formed, additionally help to enhance the ability of the tips 130 to sever and compact the refuse. The shoulders 189 form a flat surface which can be used to compact the refuse as the wheel 14 rotates, and the intersection between the surface facets 156 and the shoulders 189 form a plurality of sharp edges 190 to enhance the severing capability of the tip 130.

Atop the intermediate section 174 is the top section 176. As will be noted, it dimensionally mimics the transition from the bottom section 172 to the intermediate section 174. More specifically, the top section 176 may include a constant thickness 191 but a width which has its widest point 192 at a bottom surface 193 of the top section 176 and which has its most narrow point 194 at a top surface 195 of the top section 176. In fact, in the depicted embodiment, the top surface 195 forms a pointed apex 196 where side surfaces 197 of the top section 176 intersect.

Similar to the relationship between the intermediate section 176 and bottom section 172, it will be noted that the thickness 191 of the top section 176 is substantially less than that of the intermediate section 174. In the depicting embodiment, the thickness 191 is roughly half of that of the thickness 184 of the intermediate section 174, but it is to be understood that in alternative embodiments, different dimensions between the bottom and intermediate section are possible and within the scope of the present invention. Again, similar to the transition between the bottom section 172 and the intermediate section 174, the top surface 188 of the intermediate section 174 forms a shoulder 198. The shoulder 198 in the depicted embodiment is substantially parallel to the shoulder 189 but in alternative embodiments need not be. The shoulder 198 facilitates compaction while limiting packing of refuse between the tips in a manner similar to that of the shoulder 189. Moreover, the shoulder 198 and surface facet 156 of the intermediate section 174 form a sharp edge 199 to facilitate severing and destruction of the refuse.

### INDUSTRIAL APPLICABILITY

In general, the teachings of the present disclosure may have significant industrial applicability with respect to compactors, including, but not limited to, land fill compactors. By providing tips radially extending from the wheels of the compactor as indicated above, not only can the refuse be efficiently compacted, severed and otherwise diminished in size, but the ability of the refuse to pack in and around the tips is greatly reduced relative to prior art compactors and wheel tips. In addition, the provision of the various side surface facets, scalloped portions, shoulders and sharp edges of the disclosed tip also enhances the ability of the tip, wheel and compactor to compact the refuse relative to prior art designs.

In operation, the compactor tips are welded or otherwise adhered to the rim of a wheel of a compactor. When the compactor is caused to move, the wheels rotate and thus the tips rotate as well. Upon rotation, the tips extend into and push against the refuse. The weight of the compactor and shape of the rim and tips cause the refuse to compact. More specifically, not only are the air spaces between the refuse condensed, but the relative sizes of the pieces of refuse are reduced in that the tips sever or otherwise destroy the shape of the refuse. As the wheel and tips continue to rotate, the shape of the tips substantially prevents the refuse from packing in the round of the tips. More specifically, prior art tips having relatively flat or constant side surfaces may lend themselves to adherence of moist or malleable refuse. However, by providing the plurality of surface facets, varying the angles of the surface facets in multiple directions, employing compound angles for same, and varying the dimensions of the side surfaces in accordance with the present invention, this ability of the refuse to pack in and around the tips is greatly reduced. Moreover, by providing the plurality of surface facets and side surfaces with the inclusion of shoulders and sharp edges therebetween, the ability of the tip to sever or otherwise destroy the refuse being compacted is improved.

From the foregoing, it can be seen that the present disclosure sets forth a compactor wheel and wheel tip that greatly improves the ability of both to prevent refuse from being packed in, around and between the tips, while at the same time improving traction and stability.

What is claimed is:

1. A compactor tip, comprising:
a tip end;
an attachment end, a longitudinal axis extending between the tip end and the attachment end; and
a plurality of surface facets disposed between the tip end and the attachment end along the longitudinal axis, wherein each surface facet is radially offset from the longitudinally adjacent surface facet.

2. The compactor tip of claim 1, wherein each surface facet lies in a particular plane, each plane being transverse to every other plane.

3. The compactor tip of claims 2, wherein at least one surface facet is triangular in shape.

4. The compactor tip of claim 1, wherein the tip includes a forward side and a reverse side, the plurality of surface facets being disposed in both the forward side and the reverse side.

5. The compactor tip of claim 1, wherein the surface facets are oriented at progressively greater angles relative to the longitudinal axis.

6. The compactor tip of claim 5, wherein the surface facets are oriented at compound angles relative to the longitudinal axis.

7. The compactor tip of claim 6, wherein the compound angles include a first angle relative to the longitudinal axis in a horizontal direction, and a second angle relative to the longitudinal axis in a radial direction.

8. The compactor tip of claim 1, wherein each surface facet is separated by a shoulder being perpendicular to the surface facets.

9. The compactor tip of claim 1, further including a plurality of side surfaces, each surface facet being flanked by first and second side surfaces wherein each of the side surfaces runs at a non-parallel angle to the longitudinal axis such that each side surface is further away from the longitudinal axis at a base of each side surface than at a top of each side surface.

10. The compactor tip of claim 9, wherein each side surface extends upwardly from another side surface therebelow, each side surface having a width, the width of each side surface being half the width of the side surface therebelow.

11. A compactor wheel, comprising:
a rim; and
a plurality of compactor tips radially extending from the rim, each compactor tip including a tip end, an attachment end, a longitudinal axis extending from the attachment end to the tip end, and a plurality of surface facets disposed between the tip end and the attachment end along the longitudinal axis, wherein each surface facet is radially offset from the longitudinally adjacent surface facet.

12. The compactor wheel of claim 11, wherein each surface facet lies in a particular plane, each plane being transverse to every other plane.

13. The compactor wheel of claim 12, wherein at least one surface facet is triangular in shape.

14. The compactor wheel of claim 11, wherein the tip includes a forward side and a reverse side, the plurality of surface facets being disposed in both the forward side and the reverse side.

15. The compactor wheel of claim 11, wherein the surface facets are oriented at progressively greater angles relative to the longitudinal axis.

16. The compactor wheel of claim 15, wherein the surface facets are oriented at compound angles relative to the longitudinal axis.

17. The compactor wheel of claim 16, wherein the compound angles include a first angle relative to the longitudinal axis in a horizontal direction, and a second angle relative to the longitudinal axis in a radial direction.

18. The compactor wheel of claim 11, wherein each surface facet is separated by a shoulder being perpendicular to the surface facets.

19. The compactor wheel of claim 11, further including a plurality of side surfaces, each surface facet being flanked by first and second side surfaces wherein each of the side surfaces run at a non-parallel angle to the longitudinal axis such that each side surface is further away from the longitudinal axis at a base of each side surface than at a top of each side surface.

20. A compactor, comprising:
a chassis;
an engine supported by the chassis; and
a plurality of compactor wheels supporting the chassis, each compactor wheel including a rim and a plurality of compactor tips radially extending from the rim, each compactor tip including a tip end, an attachment end, a longitudinal axis extending from the attachment end to the tip end, and a plurality of surface facets disposed between the tip end and the attachment end along the longitudinal axis, wherein each surface facet is radially offset from the longitudinally adjacent surface facet.
